(19) United States
(12) Patent Application Publication
(10) Pub. No.: US 2019/0195697 A1
(43) Pub. Date: Jun. 27, 2019

(54) THERMOMETER

(71) Applicant: KOREA BASIC SCIENCE INSTITUTE, Daejeon (KR)

(72) Inventors: Jalal CHENGAOU, Dreieich (DE); Kai HAEMEL, Jossgrund (DE); Sebastian HOLLUNDER, Schmitten-Niederreifenberg (DE); Martin KUBICZEK, Hofheim (DE)

(73) Assignee: KOREA BASIC SCIENCE INSTITUTE, Daejeon (KR)

(21) Appl. No.: 14/123,125

(22) PCT Filed: May 25, 2012
(86) PCT No.: PCT/EP2012/059790

§ 371 Date: Feb. 18, 2014

(30) Foreign Application Priority Data
Jul. 9, 2011 (JP) 102011107006.4

(51) Int. Cl. G01K 1/08; G01K 7/42; G01K 1/16; G01K 1/14; H01F 27/40

(52) U.S. Cl. CPC G01K 1/08; G01K 7/42; G01K 1/16; H01F 2027/406; H01F 27/402; G01K 2007/422; G01K 1/14

(57) ABSTRACT

The invention relates to a thermometer, especially for determining the winding temperature of an electric power transformer. The invention is characterised in that, in a thermometer for determining the winding temperature of an electric power transformer, an electric temperature sensor, a mechanical temperature sensor and a heating element are arranged inside a coupling part formed from a heat-conductive material, and an insulating sleeve consisting of a thermally stable material is provided between an outer wall of the coupling part and an inner wall of the housing, the housing, the insulating sleeve and the coupling part forming a coaxial structure without leaving any air gaps such that thus definable heat transfers are generated between the individual components, namely the coupling part, the insulating sleeve and the tubular housing.

The present invention relates to a thermometer, particularly for determining the winding temperature of an electric power transformer.

A method, which is known from the prior art and which is concerned with indirect measurement of the winding temperature at power transformers, is known from DE 89 11 078 U1. In this method arranged in an immersion sleeve for installation in a transformer casing filled with liquid is a hollow measuring sensor surrounded by an insulating hose around which in turn is wound an electrical heating resistance that for its part is encased by a further insulating hose. With the help of a current converter a current that is proportional to the load of the transformer, is conducted by way of the heating resistance, the size of which current is set in such a manner to the heating resistance and the heat transfer in the direction of the measuring sensor and coolant that the temperature measured by the measuring sensor corresponds with the respective mean or maximum winding temperature of the power transformer.

The immersion sensor is in that case installed in the transformer casing in such a way that the immersion sleeve is immersed in the cooling liquid of the transformer. In that regard the temperature difference between transformer winding and cooling liquid depends on the respective current in this winding. A current converter is therefore associated with the transformer and detects the current flowing across the transformer. The secondary current of this current converter is now proportional to the current flowing across the transformer. the signal current subsequently flows via a heating resistance, associated with the temperature sensor and thereby generates a read-out plot that corresponds with the respective transformer load, relative to the actually measured oil temperature. As a consequence of a calibration undertaken before placing in operation it is possible to obtain in this indirect manner an indication of the mean or maximum winding temperature for a given current load of the power transformer, i.e. the display of a display apparatus, which is downstream of the heated temperature sensor, in a thermal image of the processes within the power transformer. The display can then take place, after appropriate amplification of the measurement signals, in a control room that is distant to a greater or lesser extent. It is alternatively also possible to further electronically process the relevant measurement values in a control and regulating installation, for example to form optical and/or acoustic warning signals.

This method for simulating a displaying the winding temperature of an electric power transformer has basically proved satisfactory in practice. In this case, thermometers are installed that are acted on directly by way of a filling, which is separate from the filling of the transformer, by the temperature of the transformer filling. The thermometers used for this method are thus equipped with heating means, a mechanical sensor and an electrical sensor. The heating means has a desired thermal contact with respect to the surrounding housing tube disposed in contact with the liquid. This contact is formed by a polymer casing as well as an air gap. The heating means is divided into two heating elements, one of which surrounds the mechanical temperature sensor arranged in the interior and the second of which encloses the electronic temperature sensor arranged in the interior.

The thermal contact with respect to the surrounding housing tube in contact with the liquid is decisively determined by the air gap and the thermal resistance thereof. However, the air in this gap is not hermetically trapped. The thermal resistance of air is, however, in turn dependent again on the density thereof and thus directly on pressure as well as temperature. Consequently, the thermometer described in DE 89 11 078 U1 changes its characteristic thermal parameters with change of air pressure or temperature. Moreover, it is disadvantageous that the described thermometer thermally separates the mechanical temperature sensor and the electrical temperature sensor from one another. Differences within the tolerances of each sub-system therefore lead to significant discrepancies in the two temperature indication values. Preventing this involves a substantial outlay.

The object of the present invention is therefore to indicate a thermometer, particularly for determining the winding temperature of an electric power transformer, in which the influences of ambient temperature or air pressure on the determined temperature values are eliminated and in that case the differences in the measurement values between electrical temperature sensor and mechanical temperature sensor can at the same time be reduced as far as possible.

This object is fulfilled by a thermometer with the features of the first claim. The subclaims in that case relate to particularly advantageous developments of the invention.

The significant aspect according to the invention consists, in the case of a thermometer for determining the winding temperature of an electric power transformer, of arranging an electrical temperature sensor as well as a mechanical temperature sensor and a heating element within a coupling member that is made from a thermally conductive material, and providing an insulating sleeve of thermally stable material between an outer wall of the coupling member and an inner wall of the housing, wherein the housing, the insulating sleeve and the coupling member form a coaxial construction, without leaving an air gap, in such a manner that definable heat transfers between the individual components, namely the coupling member, the insulating sleeve and the tubular housing, are thus achievable. Due to the fact that in accordance with the invention the heating element, the electrical temperature sensor and the mechanical temperature sensor are arranged in common coupling member with good thermal conductivity and the thermal resistance with respect to the surrounding liquid is additionally formed by a solid thermal insulator without air cushions being able to form in the intermediate spaces within the thermometer according to the invention there is created, overall, a thermometer construction that was significantly simplified in its thermal equivalent circuit diagram and thus ultimately supplies more accurate measurement values.

The invention shall be explained in more detail in the following by way of example on the basis of figures, in which:

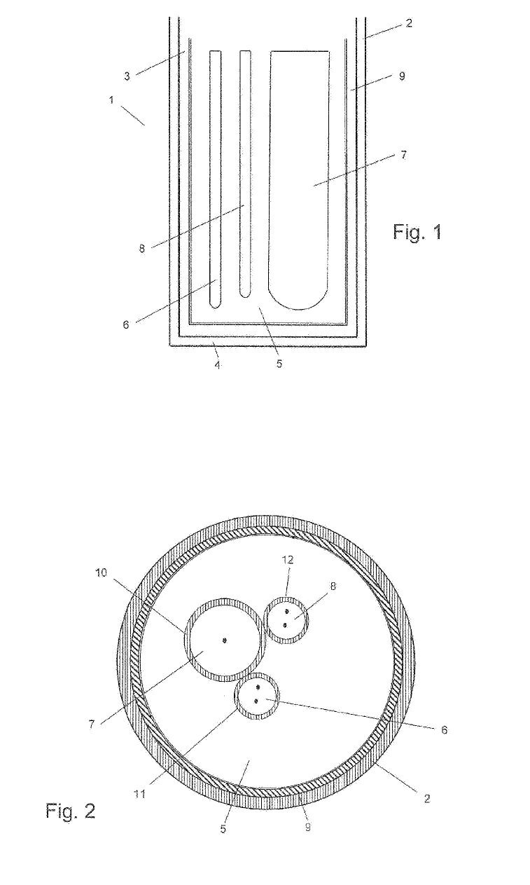

FIG. 1 shows an thermometer according to the invention in a side sectional illustration and a plan view and

FIG. 2 shows a thermometer according to the invention in a plan view.

The thermometer 1 according to the invention is shown in FIG. 1 in a side sectional illustration. In that case, the thermometer 1 is surrounded by an outer housing 2 of tubular construction that has an open end 3 and a closed end 4. Provided within the housing 2 is a coupling member 5 that is made of a material with good thermal conductivity and that has several recesses of precise fit, shown in FIG. 2, for receiving a heating element 6, a mechanical temperature sensor 7 and an electrical temperature sensor 8 that is equipped with two sensor elements. An insulating sleeve 9 made from a thermally stable material is tightly fitted between the inner wall of the housing 2 and the outer wall of the coupling member 5 so that ultimately no air gap can form between the housing 2, the insulating sleeve 9 and the coupling member 5. Considered overall, there thus results through the housing 2, the insulating sleeve 9 and the coupling member 5 a coaxial construction, without leaving an air gap, in such a kind that definable heat transfers between the individual components, namely the coupling member 5, the insulating sleeve 9 and the tubular housing 2, are thereby created. According to the invention an arrangement is thus provided, the thermal resistance of which within the coupling member 5 is so small by comparison with the internal thermal resistance of the insulating sleeve 9 that an isothermal overall arrangement of the thermometer 1 can be assumed. The coupling member 5 can in that case be made from, for example, an aluminum alloy, whilst the insulating sleeve 9 can be produced from, for example, polyetheretherketone, also termed PEEK. The thermal transfer resistance of the coupling member 5 relative to that of the insulating sleeve 9 and the thermal transfer resistance of the insulating sleeve 9 relative to that of the housing 2 are decisively determined by the geometric dimensions of the coaxially selected construction of the thermometer 1 and not by the air gap present therebetween, since this is kept very small, i.e. less than 0.1 millimeters, and thus negligible in consideration of the thermal equivalent circuit diagram.

FIG. 2 shows in sectional illustration the plan view of the thermometer 1 according to the invention. The coaxial construction of the thermometer 1 according to the invention, consisting of the outer housing 2, the insulating sleeve 9 connected therewith and the coupling member 5 for reception of the heating element 6, the mechanical temperature sensor 7 and the electrical temperature sensor 8, is readily evident from this illustration. These last-mentioned components 6, 7 and 8 are received in, particularly pushed into, a plurality of recesses 10, 11 and 12 provided in the coupling member 5. The simple pushing of the heating element 6, the mechanical temperature sensor 7 and the electrical temperature sensor 8 into the coupling member 5 in that case enables particularly uncomplicated exchange of these components 6, 7 and 8 in the event of a defect or maintenance operations that might arise.

1. A thermometer for determining the winding temperature of an electrical power transformer, the thermometer comprising:
a tubular housing with a closed end and an open end;
a coupling member inside the housing holding an electrical temperature sensor and a mechanical temperature sensor and a heating element within the tubular housing, the coupling member being made from a material with good heat conductivity;
an insulating sleeve of a thermally stable material between an outer wall of the coupling member and an inner wall of the housing, the housing, the insulating sleeve and the coupling member forming a coaxial construction without an air gap such that definable heat transfers between the the coupling member, the insulating sleeve and the tubular housing, are thereby achievable.

2. The thermometer according to claim 1, wherein the coupling member is constructed as an integrally formed part having a plurality of recesses into which the mechanical temperature sensor, the electrical temperature sensor and the heating element can be pushed without leaving an air gap.

3. The thermometer according to claim 1, wherein the coupling member is produced from a material having thermal conductivity better by a multiple by comparison with the insulating sleeve.

4. The thermometer according to claim 1, wherein the coupling member is formed by an aluminum alloy.

5. The thermometer according to claim 1, wherein the insulating sleeve is made from polyetheretherketone.

6. The thermometer according to claim 1, wherein an internal thermal resistance of the material of the coupling member is significantly lower by comparison with an internal thermal resistance of the material of the insulating sleeve such that an isothermal overall arrangement of the thermometer is thereby created.
